(19) United States
(12) Patent Application Publication
(10) Pub. No.: US 2009/0294190 A1
(43) Pub. Date: Dec. 3, 2009

(54) Electrical Gearbox With Continuous Variation

(76) Inventors: Jörg Oldenburg, Oederquart (DE); Jan Neumann, Alfstedt (DE)

Correspondence Address: Clements Bernard PLLC, 1901 Roxborough Road, Suite 250, Charlotte, NC, 28211, US

(21) Appl. No.: 11/988,350

(22) PCT Filed: Jul. 3, 2006
(86) PCT No.: PCT/EP2006/063800

§ 371 Date: Nov. 25, 2008

(30) Foreign Application Priority Data
Jul. 4, 2005 (EP) 05106043.2

(51) Int. Cl. B60K 6/543

(52) U.S. Cl. 180/65.22; 180/65.21

(57) ABSTRACT

An electric transmission comprises an input shaft (10, 11) connectable to a drive means, such as an internal combustion engine. The input shaft (10, 11) is connected to an output shaft (20, 60) through an electric power transmission means (88, 66). Here, the electric power transmission means (88, 66 and 18, 26, 42, 46) comprises magnets (26, 42, 88) connected to the input shaft (10, 11), said magnets inducing power into coils (26, 66) connected with the output shaft (20, 60). Using a switching means (46, 68) connected to the coils (26, 66), a magnetic force is generated that causes the rotation of the output shaft (20, 60).

### RELATED FOREIGN APPLICATION

The present application claims the priority of the European PCT application PCT/EP/2006/063800 filed Jul. 3, 2006, the disclosure of which is incorporated herein by reference.

### BACKGROUND OF THE INVENTION

1) Field of the Invention

The invention is directed to a continuously variable electric transmission.

2) Prior Art

With conventional geared transmissions, the speed is gradually variable, frictional clutches or hydraulic clutches being provided for shifting the gears in a geared transmission. Although such transmissions have a high mechanical efficiency, they are still disadvantageous in that in most cases the gradual speed control does not allow to use the optimum speed range of an internal combustion engine, for example. Consequently, the energetic overall efficiency of the transmission and the internal combustion engine is generally rather poor.

Further, continuously variable transmissions using belts or push link chains are known. These are advantageous in that they allow for a continuously variable speed control. However, providing belts has a drawback in that these are subject to important influences causing their aging and in that the overall efficiency of such transmissions is rather poor. Push link chain transmissions are disadvantageous in that the maximum transmissible torque is rather limited when compared to geared transmissions.

Moreover, hydrostatic drives are known for vehicles with low vehicle speeds, such as construction machines and tractors, for example. In these drives, the power of the internal combustion engine is transformed into an oil flow which then drives an oil engine. Although the mechanical efficiency of a hydrostatic drive is rather poor, comparatively good overall efficiencies can be achieved in combination with a highly sophisticated transmission/engine management. However, besides the low vehicle speed achievable, such transmissions have the disadvantage of rather high manufacturing costs.

Since electric motors are well controllable, it is further known to use an internal combustion engine to drive a generator for generating electric energy and to control the speed by a modulation of the frequency, the voltage and/or the electric current. Since the efficiency of the individual components internal combustion engine, electric generator, control and electric motor multiply, such machines have a rather poor overall efficiency.

### Basic Principles—Functionality of an Electric Machine:

Rotating electric machines are energy converters transforming electric energy and mechanic energy. The performance of an electric machine is determined, on the one hand, by the magnitude of the electric voltage U and the current 1 and, on the other hand, by the torque M and the speed of rotation n.

### Electric Generator:

An externally driven moving part (rotor) induces an electric field into a stationary part (stator) provided with windings, if differential speeds exist between the rotor and the stator. In the stator winding, this field causes an electric power upon the occurrence of a short circuit or a load. By the flow of power in the stator, a (return) torque is created.

### Electric Motor:

Conversely, a flow of power in the stator causes a torque on the rotor.

It is an object of the present invention to provide a continuously variable electric transmission with a high efficiency and wide speed range or a large transmission ratio spread.

The object is achieved, according to the invention, with a continuously variable electric transmission according to claim 1.

### SUMMARY OF THE INVENTION

The invention refers to a continuously variable electric transmission having a high mechanical efficiency and being useful in a wide range of speeds. According to the invention, the spatial separation of generator and motor, common so far, is eliminated and these components have been assembled to form a unit.

Here, the stator is not supported fixedly, but rotatably. In the electric transmission described herein, the rotor is configured as a rotatably input shaft and the stator is designed as a rotatable output shaft (it is possible both to provide the rotor at the input side and the stator at the output side, and to provide the stator at the input side and the rotor at the output side).

According to the invention, the input shaft is connected to an output shaft through an electric force transmitting element. Here, the electric force transmitting element is generally provided with magnets connected with the input shaft, the magnets inducing power into coils connected to the output shaft. As provided by the invention, the input and output shafts are not positively engaged with each other for transmitting the rotary movement from the input shaft to the output shaft.

Possibly, a mechanical and/or electric transmission may be provided between the input and output shafts for controlling the speed.

By opening a switch that short-circuits a coil, for example, the torque is reduced so that the speed of the output shaft is reduced. The speed control is thus achieved using a load-dependent generation of a torque. This may be effected by a variation of the electric power. It is also possible to tap electric power and to use the same for other consumer loads, for example, or to supply it to a battery or an accumulator, respectively.

Preferably, the switching means comprises a modulation means allowing for a modulation of the frequency, the voltage and/or the current. Thereby, it becomes possible to vary the speed of the output shaft continuously. It is particularly preferred in this context to integrate the modulation means in electronic switches.

The magnets connected to the input shafts could at least partly be formed as solenoids. By an electric excitation of the magnets, magnetic fields of different strengths may be generated. This causes a change in the voltage induced into the coils and thus influences the speed of the output shaft.

The electric transmission of the present invention has the particular advantage that a high overall efficiency of preferably more than 90% can be achieved. Further, the weight of the transmission is very low when compared to known transmissions. Moreover, the overall thermal losses are extremely low and amount to only about half of those in hydrostatic transmissions, for example. Since the transmission operates without oil, except for lubricants, the manufacturing costs are relatively low. Further, the transmission is a low wear transmission, since especially no mechanical shifting processes are performed. Moreover, the structure of the transmission is variable so that it can readily be adapted to the individual speed ranges of particular fields of application.

### DESCRIPTION OF THE DRAWINGS

The above common aspects of the invention are particularly evident from the two variants thereof described below with reference to the drawings. In the Figures:

FIG. 1 is a schematic sectional view of a first preferred embodiment of the invention, and

FIG. 2 is a schematic sectional view of a second preferred embodiment of the invention.

### DESCRIPTION OF THE INVENTION

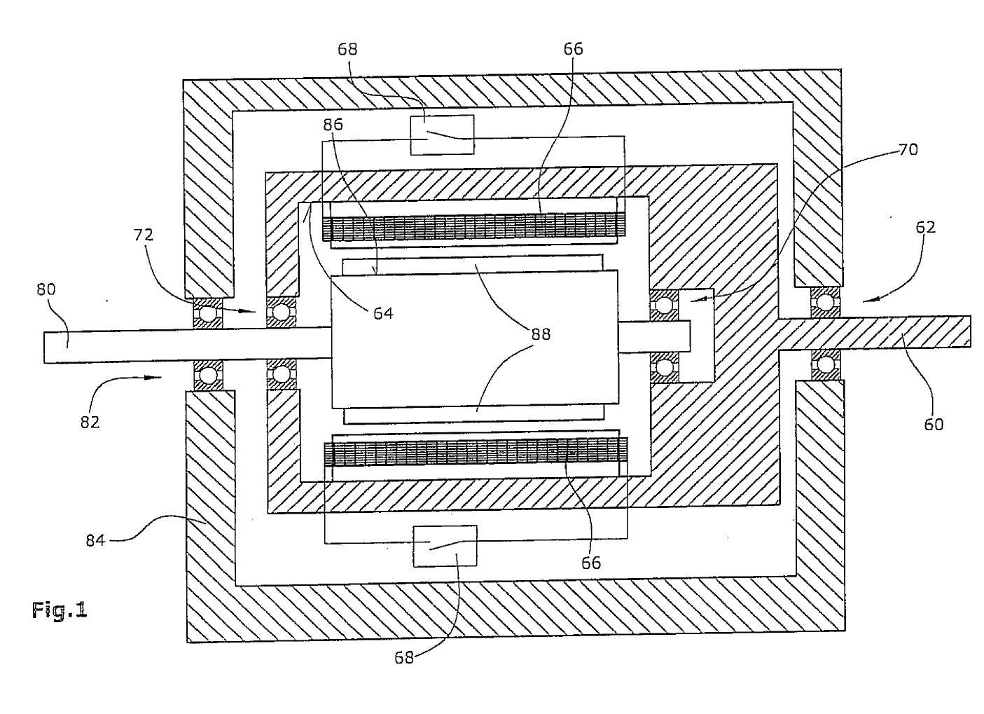

In a first preferred variant, the electric transmission of the present invention (FIG. 1) comprises an input shaft 80 connectable to a drive means. The drive means may be an internal combustion engine, for example.

Further, the transmission comprises an output shaft 60, the input shaft 80 and the output shaft 60 being connected via an electric force transmission means. The input and output shafts are not positively connected. An electric field is established between the input shaft 80 and the output shaft 60, which causes a torque which as a drag torque, depending on the load, has the output shaft 60 follow the input shaft 80.

Since the drag torque of the transmission, like all other mechanical resistances in the transmission, always result in the output shaft 60 being dragged along by the input shaft 80, the mechanical efficiency of the transmission is increased, as provided by the invention.

For controlling the speed of the output shaft 60 with respect to the speed of the input shaft 80, a load-dependent torque control is required. This is achieved either by varying the electric power or via the generation of electric power, which in the latter case could be supplied completely or partly to further consumer loads or accumulators.

The first preferred embodiment of the electric transmission (FIG. 1) comprises an input shaft 80 supported at the input side by a bearing 82 in a housing 84. Magnets 88 are provided on the outside 86 of the input shaft.

The input shaft 60 is also supported in the housing 84 by a bearing 62. The output shaft 60 is partly superposed on the input shaft 80, the portion of the output shaft 60 surrounding the input shaft 80 being formed as a hollow shaft. In this portion, the inner surface 64 of the output shaft 60 is provided with coils 66 located opposite the magnets 88. By rotating the input shaft 80, which may be connected to a drive means such as an internal combustion engine, the magnets 88 induce a voltage into the coils 66. The individual coils 66 may be short-circuited by switch means 68. By shirt-circuiting a coil 66, a magnetic field is built up. This field interacts with the magnets 88 such that a rotation of the output shaft 60 is caused.

Using the electric force transmission means of the coils 66 and the magnets 88, the speed of the input shaft 80 is transmitted onto the output shaft 60. This occurs because of the electric field established between the input shaft 80 and the output shaft 60, the field generating a torque. Due to such a “drag moment”, the output shaft 60 follows the input shaft 80 depending on the load. According to the invention, this is achieved by individual or all coils 66 being short-circuited. The speed of the input shaft 60 may be controlled by short-circuiting only individual coils 66 via the switches 68. Likewise, electronic modulatable switches may be provided to be able to vary the current flowing through the coils 66. Further, the magnets 88 may be configured as solenoids so that their induction power is also variable.

Besides being supported by the bearing 82, the input shaft 80 is supported by another bearing 70 within the output shaft 60. Besides being supported by the bearing 62, the output shaft 60 is supported by a bearing 72 which is supported on the input shaft 80.

### Control of the Differential Speeds Between the Input and Output Shafts.

Power transmission requires the presence of a differential speed between the input and output shafts. The following control variants are conceivable to change transmissible torques and output speeds:

1. Short-circuited stator windings (or technical alternatives) and permanent magnets or non-controlled solenoids on the rotor.
2. Short-circuited stator windings and controllable solenoids on the rotor.
3. Permanent magnets or non-controlled solenoids on the rotor and stator windings that can be short-circuited through switches.
4. A combination of solution 2 and 3, i.e. controllable solenoids on the rotor in combination with stator windings, adapted to be short-circuited via switches.

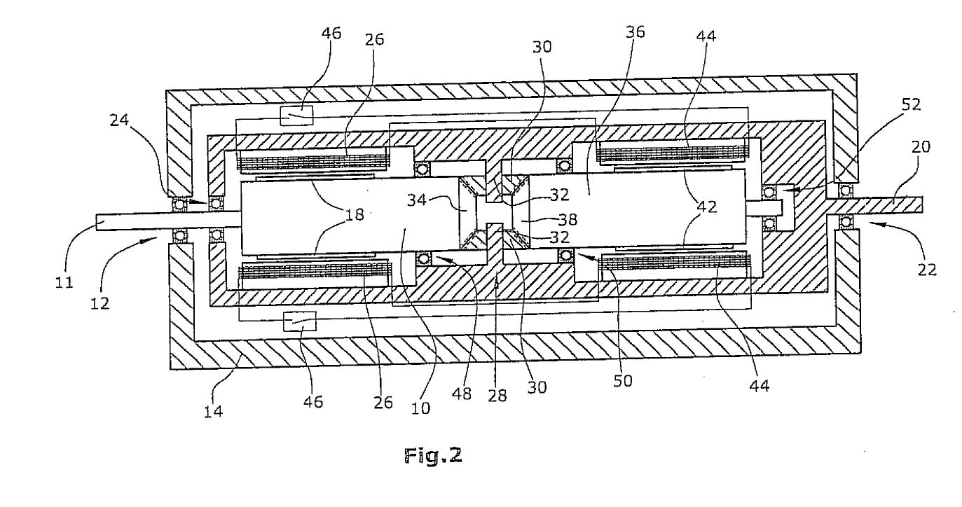

The present electric transmission according to the second preferred embodiment (FIG. 2) comprises an input shaft connectable to a drive means 11. Here, the drive means may be an internal combustion engine, for example. The transmission further has an output shaft 20, the input shaft and the output shaft being connected through an electric power transmission means. A proportional transmission comprised of gears 30-34 and 38 is supported by the output shaft. A split rotor is used that comprises a generator part 10 and a motor part 36. Due to the synchronous gears supported in the output shaft, both parts rotate in opposite directions. The speeds and directions of the generator and motor parts are inversely proportional to the differential speed between the generator part 10 of the input shaft 11 and the output shaft 20, or the rotor and the stator, respectively.

This proportionality is achieved by the gears 30, 34, 38, which rotate the two rotor halves in opposite directions, being supported on one (or a plurality of) shaft(s) 32 (or half shafts) which in turn is supported in the output shaft 20, 28 (or the stator, respectively).

The generation of a torque acting between the input and output shafts and causing the output shaft to be entrained by the input shaft is effected in two stages:

1. by generating electric power in the generator part, and
2. by consuming the electric power generated in the generator part in the motor part of the transmission.

The input shaft 11 in the generator part 10 of the transmission rotates in the same direction as the output shaft 20, leading the same. The input shaft in the motor part 36 moves proportionally opposite to the input shaft 11 and thus opposite to the output shaft 20.

Both forces act in the same direction: the torque caused by the generation of power acts as a drag torque on the output shaft 20, like the torque generated by the motor power acts as a thrust moment on the output shaft 20. Both moments, acting in the same sense of rotation with respect to the output shaft 20, add to form the total moment.

Due to the synchronous gears, the speeds of the input shaft in the generator part 10 of the transmission are, in absolute terms, inversely proportional to the speeds in the motor part 36 of the transmission. As a result, (provided that equal numbers of magnets exist in the generator and in the motor part of the transmission) the frequencies between the input shaft in the generator part of the transmission and the output shaft, and between the input shaft in the motor part of the transmission and the output part always have the same level, regardless of the frequency itself. Therefore, it is not necessary to perform a modulation of the frequencies (which always decreases the power) to control the power.

Since the drag torque of the generator part of the transmission, as well as the thrust moment in the motor part of the transmission and all other mechanical resistances in the transmission generally cause the output shaft 20 to be entrained by the input shaft 11, the mechanical efficiency of the transmission is increased by the present invention.

The second preferred embodiment of an electric transmission comprises an input shaft 11. In the embodiment illustrated, the input shaft 11 is supported on the input side by a bearing 12 in a housing 14. The input shaft 11 has a plurality of magnets 18 (on generator part 10) distributed circumferentially on the outside. The input shaft 11 is connected to an input or output means, such as an internal combustion engine.

An output shaft 20 is also supported in the housing 14 by means of a bearing 22 and, on the opposite side, it is supported on the input shaft 11 by a bearing 24. The output shaft 20 is partly formed as a hollow shaft so that the input shaft 11 is surrounded by the output shaft 20 at least in the portion in which the magnets 18 are arranged. Opposite the magnets 18, the output shaft 20 carries several coils 26. Since a relative movement occurs between the magnets 18 and the coils 26, the magnets 18 and the coils 26 act as a first electric power transmission means because the magnets 18 induce power into the coils 26.

By means of the first electric power transmission means 18, 26, the speed of the input shaft 11 is transmitted to the output shaft 20. This occurs because of the electric field established between the input shaft 11 and the output shaft 20, the field generating a torque. Due to such a “drag torque”, the output shaft 20 follows the input shaft 11, depending on the load. According to the invention, this is achieved by short-circuiting individual or all coils 26 or by connecting them to the motor part.

In the second embodiment illustrated (FIG. 2), a mechanical transmission having at least one or a plurality of gears 30 is shown, the gears being rotatably supported on a transverse axis 32. The transverse axis 32 is fixedly connected to the output shaft 20 which is also hollow in this portion. The gears 30 mesh with a toothed gearing 34 provided at the front end of the input shaft 11, on the generator part 10.

On the side opposite the front toothed gearing 34, a motor part in the form of an intermediate shaft 36 is provided coaxially with the input shaft 11. The intermediate shaft (motor part) 36 also comprises a front toothed gearing 38 which also meshes with the gears 30.

By rotating the input shaft 11, the rolling speed of the gears 30 on the front toothed gearing 34 is varied. This causes a change in the speed of the intermediate shaft (motor part) 36 connected with the gears 38 through the transverse axis 32. For the rotation of the output shaft 20, the same has its inner surface provided with coils 44, the coils 44 preferably being regularly distributed over the circumference. The coils 44 are preferably arranged similar to the coils 26.

The coils 44 are provided in a condition mechanically decoupled from the opposite magnets 42, positioned on the intermediate shaft 36 (motor part). The current flowing in the coils generates a magnetic field. The magnetic force produced thereby acts on the magnets 42 and causes the output shaft 20 to rotate. This forms the second power transmission means.

A variation of the torque can be achieved, for example, by having only a part of the coils 44 generate a magnetic field or by varying the intensity of the magnetic fields generated by the coils 44.

In the embodiment illustrated, the power supply to the coils 44 is provided using the first electric power transmission means 18, 26, wherein one or a plurality of switching means 46 are provided.

In the embodiment illustrated, the input shaft 11 is preferably supported, in addition to the bearing 12, by a bearing 48 arranged between the generator part 10 of input shaft 11 and the output shaft 20.

The intermediate shaft 36 is preferably supported by two bearings 50, 52 disposed inside the output shaft 20. The bearing 50 is positioned between the motor part of the intermediate shaft 36 and the output shaft 20. Bearing 52 is disposed between the intermediate shaft 36 and the output shaft 20.

When comparing the electric transmission of the present invention with an electric motor or generator, the input shaft 11 corresponds to the rotor and the output shaft 20 corresponds to a stator, which in this instance is a “rotatable stator”. Thus, the input shaft 11 and the intermediate shaft 36 correspond to a split rotor whose parts are connected via the mechanical transmission 30, 32, 34 which, in particular, is a proportional transmission. On the left in FIG. 2, the split rotor has a generator part 10 and a motor part 36 on the right. Both parts move in opposite senses because of the mechanical transmission 30, 32, 34. The speed and the sense of the generator part and of the motor part are thus inversely proportional. This proportionality is achieved by supporting the gears 30, 32, 34 that make the two rotor halves rotate in opposite senses, on one (or a plurality of) shaft(s) 32 (or half shaft) which in turn is supported in the output shaft 20, 28 (or the stator, respectively).

To control the speed of the output shaft with respect to the speed of the input shaft, a load-dependent torque generation is required. This is achieved exclusively through a variation of the electric power, regardless of the frequency of the electric power. As a rule, the entire electric power generated in the generator part of the transmission is transformed in situ to motor power. Generally, only the power generation is controlled, but the generated power itself is not modulated (in a manner decreasing power).

### Control of the Differential Speeds Between the Input and Output Shafts.

A transmission of power requires that the output speed is lower than the input speed. The following control variants for changing transmissible torques and output speeds are conceivable:

1. Short-circuited stator windings (or technical alternatives) and permanent magnets or non-controlled solenoids on the rotor.
2. Short-circuited stator windings and controllable solenoids on the rotor.
3. Permanent magnets or non-controlled solenoids on the rotor and stator windings that can be short-circuited through switches.
4. A combination of solution 2 and 3, i.e. controllable solenoids on the rotor in combination with stator windings, adapted to be short-circuited via switches.

The above possible ways of control 1-4 are possible in the “generator” part 10 of the transmission without using the motor part 36. Generally, the generator and motor parts of the transmission are used, whereby the following additional possibilities for control are obtained in the motor part:

5. Controllable solenoids on the rotor.
6. Permanent magnets or non-controlled solenoids.
7. Partly connected stator coils fed by the generator part of the transmission or by external power sources.

It is also possible to discharge the electric power entirely or in part to an external consumer load or an accumulator. Further, it is possible to combine the transmission with an electric motor transforming electric power coming from an accumulator, for example, into an additional or unique support to the torques, power and speed of the output shaft.

1. An electric transmission comprising an input shaft (11) adapted to be connected to a drive means, an output shaft (20) connected to the input shaft (11) via an electric power transmission means (18, 26), the electric power transmission means (18, 26) comprising magnets (18) connected with the input shaft (11) and inducing a power into coils (26) connected to the output shaft (20), and a switching means (46), connected with the coils (26), for generating a magnetic force causing a rotation of the output shaft (20),
characterized in that
a mechanical transmission (30, 32, 34) is arranged between the input shaft (11) and the output shaft (20), the transmission being connected with a second electric power transmission means (36, 42, 44) for varying the speed between the input shaft (11) and the output shaft (20).

2. The electric transmission of claim 1, characterized in that the magnetic force is provided by short-circuiting individual and/or all coils (26).

3. The electric transmission of claim 1, characterized in that the mechanical transmission (30, 32, 34) has toothed gearing elements (30, 34), especially a bevel-shaped toothed gearing or optional alternatives.

4. The electric transmission of claim 3, characterized in that the gearing elements (30, 34) are connected to the output shaft (20) via a transverse axis (32) which, in particular, carries at least one gear (30).

5. The electric transmission of claim 1, characterized in that the input shaft (11) comprises a front toothed gearing (34) cooperating with said at least one gear (30).

6. The electric transmission of claim 1, characterized in that the second electric power transmission means (42, 44) is connected to the mechanical transmission (30, 32, 34) via an intermediate shaft (36).

7. The electric transmission claim 6, characterized in that the intermediate shaft (36) comprises magnets (42) and/or coils cooperating with coils (44) and/or magnets mechanically decoupled from the intermediate shaft (36) for generating a torque.

8. The electric transmission of claim 7, characterized in that magnets and/or coils (44) mechanically decoupled from the intermediate shaft (36) are carried by the output shafts (20).

9. The electric transmission of claim 1, characterized in that the input shaft (10, 11) and the output shaft (20, 60) are at least partly superposed in the axial direction.

10. The electric transmission of claim 1, characterized in that the input shaft (10, 11) and the output shaft (20, 60) are at least partly superposed in the axial direction.

11. The electric transmission of claim 1, characterized in that the modulation means is integrated in electronic switches.

12. The electric transmission of claim 1, characterized in that the magnets (18, 88) are at least partly designed as solenoids and are preferably connected with a switching means.

13. The electric transmission of claim 1, characterized in that the switching means (46, 68) comprises a modulation means, especially for modulating the frequency and/or the voltage and/or the current.

14. The electric transmission of claim 1, wherein the speed control is effected by means of a load-dependent torque generation.

15. The electric transmission of claim 1, wherein a part or the entire electric power can be discharged to other consumer loads or accumulators.

16. (canceled)
